(19) United States
(12) Patent Application Publication
(10) Pub. No.: US 2026/0317521 A1
(43) Pub. Date: Oct. 15, 2026

(54) METHOD OF VIS-BREAKING A POLYOLEFIN

(71) Applicant: SAHARA INTERNATIONAL PETROCHEMICAL CO. (SIPCHEM), Al-Khobar (SA)

(72) Inventors: Mohammed Riyazuddin FAROOQUI, Al-Khobar (SA); Cristovao DE LEMOS, Al-Khobar (SA); Khalid OBAID KHULAIF, Al-Khobar (SA); Ammar JAMAL MAKKI, Al-Khobar (SA); Hosam S. AL-QARIHI, Al-Khobar (SA); Tahir I. ALVI, Al-Khobar (SA)

(73) Assignee: SAHARA INTERNATIONAL PETROCHEMICAL COMPANY (SIPCHEM), P.O. Box 130 (SA)

(21) Appl. No.: 19/176,581

(22) Filed: Apr. 11, 2025

(51) Int. Cl. C08L 23/14; C08J 3/00; C08K 5/14

(52) U.S. Cl. CPC C08L 23/14; C08J 3/005; C08K 5/14; C08J 2323/14; C08J 2431/04; C08L 2207/02

(57) ABSTRACT

A method of vis-breaking a polyolefin including: mixing an organic peroxide with an ethylene vinyl acetate (EVA) copolymer to form a first mixture; melt extruding the first mixture from a first extruder at a temperature at least 10° C. lower than the half-life time temperature of the organic peroxide and at least 10° C. higher than the melting point of the EVA copolymer to form an extruded first mixture; pelletizing the extruded first mixture to form a cross-linkable EVA composition; mixing the cross-linkable EVA composition and the polyolefin to form a second mixture; and, melt extruding the second mixture from a second extruder at a temperature of at least 200° C. In the intermediate cross-linkable EVA composition, the organic peroxide is encapsulated in the EVA copolymer. Further, in extruding the second mixture, the organic peroxide decomposes to concurrently crosslink the EVA and vis-break the polyolefin.

### BACKGROUND

### Technical Field

The present disclosure is directed to a method of vis-breaking a polyolefin. More particularly, the present disclosure is directed to a method of vis-breaking a polyolefin comprising melt-extruding the polyolefin in the presence of an encapsulated pro-degradant.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

In the production of polyolefins and, in particular, of polypropylene and crystalline copolymers of propylene by direct polymerization, the weight average molecular weight (Mw) of the polymerized products may be closely controlled where the intended weight average molecular weight is greater than 200000 daltons, corresponding to a melt flow rate of up to about 20 g/10 minutes, as determined at 230° C., using a 2.16 kg load cell. However, the yields of crystalline polyolefins and, in particular, of crystalline propylene polymers which are made directly in polymerization and which are intended to have a melt flow rate of greater than about 20 g/10 minutes, tend to be impractically low.

A known strategy in the art to produce lower molecular weight crystalline polyolefins comprises first polymerizing polyolefins to a higher molecular weight than desired for the final application and then subjecting said higher molecular weight polymerized products to chain scission to achieve the desired molecular weight. The process of chain scission is termed visbreaking and is intended to reduce the melt viscosity of the polymer and increase its melt flow index. The resultant visbroken polymer should thereby have a controlled rheology and may further have a narrowed molecular weight distribution and reduced average molecular weight.

A number of different methodologies have been employed for visbreaking polyolefins, of which important examples include: thermal pyrolysis, wherein the polymer is exposed to high temperatures in the absence of air or other reagents; treatment of the polymer with strong oxidizing agents; exposure of the polymer to ionizing radiation; and, treatment of the polymer with a prodegradant. The poor heat transfer characteristics of high molecular weight polyolefins imposes a need for very high temperatures in thermal pyrolysis-such as temperatures of 350° C. or greater—which represent an unattractive energy demand for commercial applications. Oxidative chain scission is often associated with poor control of the molecular weight reduction of polymer visbreaking. The exposure of polyolefins to ionizing radiation-such as gamma or beta radiation—of sufficient intensity may serve to rupture C—C and C—H chemical bonds with the concomitant generation of free radical sites: whilst such scissioning is effective, it is not ubiquitously applied on account of the cost and hazard of ionizing radiation and the difficulty of obtaining uniform irradiation. Given these identified deficiencies in the other noted methodologies, the treatment of polyolefins with pro-degradants is recognized as an important commercial visbreaking methodology and is the overarching subject of the present disclosure.

A pro-degradant is a substance which promotes chain scission when mixed with the polymer to form a mixture, which mixture is then heated under extrusion conditions. Pro-degradants initiate a free radical chain reaction resulting in scission of the polyolefin molecules.

U.S. Pat. No. 10,316,115A (Karjala et al.) describes a process to prepare a second propylene-based polymer from a first propylene-based polymer, each propylene-based polymer having a melt flow rate (MFR; 2.16 kg/230° C.) with the melt-flow rate of the second propylene-based polymer being greater than the melt-flow rate of the first propylene-based polymer. The described process comprises contacting under visbreaking conditions the first propylene-based polymer with at least one carbon-carbon (C—C) free-radical initiator of Structure (I): (R¹) (R³ (R⁵)C—C(R³) (R⁴) (R⁵), wherein R¹, R², R³, R⁴, R⁵ and R⁶ are each, independently, a hydrocarbyl group or a substituted hydrocarbyl group, and wherein, optionally, two or more R groups (R¹-R⁶) form a ring structure.

U.S. Pat. No. 6,620,892 B1 (Bertin et al.) discloses a process for producing a controlled-rheology resin, said process comprising adding at least one stable free radical to a resin comprising a propylene homopolymer or copolymer, wherein the at least one stable free radical is selected from nitroxyl radicals.

The use of organic peroxides a pro-degradants is also known. The higher melt flow rate products obtained by vis-breaking polyolefins using such organic peroxides alone tend to show good processability but poor physical properties, such as insufficient impact strength and strain-at-break. Moreover, some yellowing of the obtained products may be observed. To mitigate these effects, certain authors have proposed the use of additives in combination with the organic peroxide pro-degradant. For example, U.S. Pat. No. 11,248,114 B2 (Peterson et al.) describes a method of creating a modified heterophasic polyolefin composition, whereby a polyolefin composition having at least two phases is melt-mixed with an organic peroxide free radical generator and a compatibilizing agent having at least one nitroxide radical and at least one unsaturated bond capable of undergoing a radical addition reaction. Whilst this compatibilizing agent is purported to improve melt flow rate and to modify impact strength, the addition of such additives may not be economical. Moreover, it is considered that some neutralization of organic peroxide radicals with nitroxide radicals may occur during the melt extrusion process, reducing the efficacy of the added organic peroxide.

There is a need in the art to develop a visbreaking process which utilizes organic peroxide pro-degradants but for which the visbroken products demonstrate limited yellowing and advantageous melt flow rates without compromising the impact strength and tensile properties of the products.

### SUMMARY

In an exemplary embodiment, a method of vis-breaking a polyolefin is described. The method comprises: mixing an organic peroxide with an ethylene vinyl acetate (EVA) copolymer to form a first mixture; melt extruding the first mixture from a first extruder at a temperature at least about 10° C. lower than the half-life time temperature of the organic peroxide and at least about 10° C. higher than the melting point of the EVA copolymer to form an extruded first mixture; pelletizing the extruded first mixture to form a crosslinkable EVA composition; mixing the cross-linkable EVA composition and the polyolefin to form a second mixture; and, melt extruding the second mixture from a second extruder at a temperature of at least about 200° C. In the cross-linkable EVA composition the organic peroxide is encapsulated in the EVA copolymer. Further, in the extrusion of the second mixture, the organic peroxide decomposes to concurrently crosslink the EVA and vis-break the polyolefin.

In certain embodiments, the polyolefin is selected from the group consisting of polypropylene homopolymers, polypropylene random copolymers and polypropylene heterophasic copolymers.

In certain embodiments, the polyolefin is a polypropylene random copolymer comprising, based on the weight of the copolymer, from about 1 to about 20 wt. % of the reacted unit of at least one monomer C₄-C₈ 1-olefin monomer.

In certain embodiments, the polyolefin is a polypropylene heterophasic copolymer comprising, based on the weight of the copolymer: from about 80 to about 99 wt. % of the reacted units of propylene; from about 1 to about 20 wt. % of the reacted units of ethylene; and, from about 0 to about 5 wt. % of the reacted units of at least one C₄-C₈ 1-olefin monomer.

In certain embodiments, the polyolefin has a melt flow rate of from about 1 to about 30 dg/min. as determined at about 230° C. using an about 2.16 kg load cell in accordance with ISO 1133. The polyolefin may desirably have a melt flow rate of from about 1 to about 25 dg/min. as determined at about 230° C. using an about 2.16 kg load cell in accordance with ISO 1133.

In certain embodiments, the polyolefin has a melting temperature of from about 100 to about 175° C.

In certain embodiments, the polyolefin has a xylene soluble content of less than about 5 wt. %, based on the weight of the polyolefin and as determined by extraction in accordance with ASTM 5492.

In certain embodiments, the first mixture comprises, based on the weight of the first mixture: from about 0.5 to about 5 wt. % of the organic peroxide; and, from about 95 to about 99.5 wt. % of the ethylene vinyl acetate (EVA) copolymer.

In certain embodiments, the organic peroxide is selected from the group consisting of: di-t-butyl-peroxide; t-butyl-cumyl-peroxide (BCUP); dicumyl peroxide; 1,3-bis(t-butylperoxyisopropyl)benzene; 2,5-dimethyl-2,5-di-t-butylperoxyhexane; 2,5-dimethyl-2,5-di-t-butyl-peroxyhex-3-yne; 4-methyl-2,2-di-t-butylperoxypentane; and, t-butylperoxy 2-ethylhexyl carbonate.

In certain embodiments, the organic peroxide is selected from the group consisting of: dicumyl peroxide; 2,5-dimethyl-2,5-di-t-butylperoxyhexane; and, tert-butylperoxy 2-ethylhexyl carbonate. Dicumyl peroxide has a half-life temperature of 137° C.; 2,5-dimethyl-2,5-di-t-butylperoxyhexane has a half-life temperature of 134° C.; and, tert-butylperoxy 2-ethylhexyl carbonate has a half-life temperature of 121° C.

In certain embodiments, the EVA copolymer comprises, based on a total weight of the EVA copolymer: from about 60 to about 90 wt. % of the reacted units of ethylene; and, from about 10 to about 40 wt. % of the reacted units of vinyl acetate. The EVA copolymer may preferably comprise, based on a total weight of the EVA copolymer: from about 65 to about 90 wt. % of the reacted units of ethylene; and, from about 10 to about 35 wt. % of the reacted units of vinyl acetate. In a preferred embodiment, the EVA copolymer comprises, based on a total weight of the EVA copolymer: from about 70 to about 90 wt. % of the reacted units of ethylene; and, from 10 to 30 wt. % of the reacted units of vinyl acetate.

In certain embodiments, at least a fraction of the organic peroxide and at least a fraction of the EVA copolymer are mixed prior to being fed into the first extruder.

In certain embodiments, at least a fraction of the organic peroxide and at least a fraction of the EVA copolymer are separately fed into the first extruder and mixed therein.

In certain embodiments, the crosslinkable ethylene vinyl acetate composition has a gel content of from about 60 to about 95%, as determined in accordance with ASTM D2765.

In certain embodiments, the second mixture comprises, based on the weight of the mixture: from about 5 to about 20 wt. % of the cross-linkable EVA composition; and, from about 80 to about 95 wt. % of the polyolefin. The second mixture may preferably comprise, based on the weight of the mixture: from about 5 to about 15 wt. % of the cross-linkable EVA composition; and, from about 85 to about 95 wt. % of the polyolefin.

In certain embodiments, the melt extruding of the second mixture from the second extruder is conducted at a temperature of from about 200 to about 300° C., preferably from about 200 to about 250° C.

In certain embodiments, the second mixture has a residence time in the second extruder of from about 20 to about 400 seconds; and, the specific energy input to the second extruder is from about 0.1 to about 1 kWh/kg of the second mixture.

Where the aspects of the disclosure are described above as having certain embodiments, any one or more of those embodiments can be implemented in or combined with any one of the further embodiments, even if that combination is not explicitly described. Expressed differently, the described embodiments are not mutually exclusive, and permutations thereof remain within the scope of this disclosure.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart for the method of vis-breaking a polyolefin, according to certain embodiments.

FIG. 2 is an illustration of a method of preparing a crosslinkable ethylene vinyl acetate composition, according to certain embodiments.

FIG. 3 is a graphical representation of the results of thermogravimetric analysis of crosslinkable ethylene vinyl acetate compositions, according to certain embodiments.

FIG. 4A is a graphical representation of the complex viscosity of vis-broken heterophasic polypropylene copolymers, according to certain embodiments.

FIG. 4B is a graphical representation of the loss modulus of vis-broken heterophasic polypropylene copolymers, according to certain embodiments.

FIG. 4C is a graphical representation of the storage modulus of vis-broken heterophasic polypropylene copolymers, according to certain embodiments.

FIG. 4D is a graphical representation of the force response during compounding, according to certain embodiments.

FIG. 4E is a graphical representation of modulus and strain at break, according to certain embodiments.

### DETAILED DESCRIPTION

Embodiments of the present invention will now be described more fully hereinafter with reference to the accompanying drawings, wherever applicable, in which some, but not all, embodiments of the disclosure are shown.

When describing the present disclosure, the terms used are to be construed in accordance with the following definitions, unless a context dictates otherwise.

As used herein, the words ‘a,’ ‘an’ and the like generally carry a meaning of ‘one or more,’ unless stated otherwise.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The words “preferable”, “preferred”, “preferably”, “particularly” and “desirably” and synonyms thereof are used herein to refer to embodiments of the disclosure that may afford particular benefits, under certain circumstances. However, the recitation of one or more preferable, preferred, particular or desirable embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The terminology “about” can describe values ±0.1, 0.5, 1, 2, 3, 4, 5, 6, 7, 8, 9 or 10% in various embodiments. Moreover, all numerical values provided herein, save for actual examples, are approximate values with endpoints or particular values intended to read as “about” the values as recited.

As used herein, room temperature is 23° C. plus or minus 2° C.

As used herein, “ambient conditions” means the temperature and pressure of the surroundings in which the composition is located or in which a coating layer or the substrate of the coating layer is located.

The molecular weights referred to in this specification are typically measured with gel permeation chromatography (GPC) using polystyrene calibration standards, in accordance with ASTM 3536.

As used herein, the term ‘particle’ refers to a small object that acts as a whole unit with regard to its transport and properties.

Unless otherwise stated, the term ‘particle size’ refers to the largest axis of the particle. In the case of a generally spherical particle, the largest axis is the diameter.

The term ‘median particle size’ (D50), as used herein, refers to a particle size corresponding to 50% of the weight of the sampled particles being greater than and 50% of the weight of the sampled particles being smaller than the recited D50 value. Particle size is determined herein in accordance with ASTM C136 Test Method Sieve Analysis.

The term “complex viscosity” as used herein means a viscosity obtained by dynamic measurement using a rheometer. A method of measuring the complex viscosity of a composition or component thereof may, for example, be carried out using a rotational rheometer equipped with a plate, a hood, and a gap of 0.3 mm, under the conditions of a sample volume of 0.3 mL, a shear strain of 5% and an angular frequency range of at least from 100 to 0.1 Hz.

As used herein, the term “melt flow rate” or “melt flow index” refers to a measure of the ease of flow of a molten composition, which includes a polymer composition melt. It is defined as the mass of a composition, in grams, flowing in ten minutes through a capillary of a specific diameter and length by a pressure applied via prescribed gravimetric weights at prescribed temperatures. The method is described in the standard ISO 1133-1: Plastics—Determination of the melt mass-flow rate (MFR) and melt volume-flow rate (MVR) of thermoplastics.

The term “vis-breaking ratio” as used herein is the ratio of the melt flow rate of the composition comprising the cross-linked polyolefin (MFR) and which is extruded from the second extruder to the melt flow rate of the polyolefin introduced into said second extruder, each melt flow rate being determined under equivalent conditions.

The term “half-life temperature” is defined herein as the temperature at which 50 wt. % of the organic peroxide has decomposed at a specified time of 1 hour. Half-life is usually reported for dilute organic peroxide solutions in order to simulate half-life at normal use levels.

As referred to herein with respect to the ethylene vinyl acetate copolymer or composition containing said copolymer, the “gel content” thereof is determined by solvent extraction using a Soxhlet extractor in accordance with ASTM D 2765 Standard Test Methods for Determination of Gel Content Swell Ratio of Crosslinked Ethylene Plastics. This is a destructive method and conventionally a total amount of at least 15 grams of the material is required for testing. This amount may be collected by collating pellets of the composition. In the alternative, where the composition is prepared or extruded in a bulk form, such as a sheet or bar, samples of the composition may be removed from different portions of that bulk volume.

The term “thermogravimetric analysis” (TGA) is used in accordance with its standard meaning as an analytical method that records either: the mass change by temperature of a sample that is facing a controlled temperature profile, optionally under partial vacuum but more commonly under an inert gas atmosphere; or, the mass change of a sample as function of the time at which the sample is maintained at a constant temperature. Unless otherwise stated, thermogravimetric analysis (TGA) is performed herein by heating the sample at a controlled rate of temperature increase in an inert gas atmosphere.

As used herein, the term “inert gas” refers to a gas that is chemically non-reactive under the conditions of use. These gases have a stable electron configuration and do not readily form compounds with other elements or molecules. Inert gases are often used in various processes to create an environment that prevents unwanted chemical reactions, such as oxidation or combustion. Common examples of inert gases include helium, argon, neon, krypton, xenon, and nitrogen. The use of nitrogen may be mentioned in particular.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “polyfunctional”, as used herein, refers to the possession of more than one polymerizable moiety.

The term “polymer” as used herein includes, but is not limited to, homopolymers and copolymers. The term “polymer” shall further include all possible geometrical configurations unless otherwise specifically stated. Such configurations may include isotactic, syndiotactic and random symmetries.

As used herein, the term “copolymer” is intended to encompass polymers comprising the reacted units of two or more monomers. The term “copolymer” is further intended to encompass impact, block, graft, random and alternating copolymers.

It will be understood that the subscripts of polymers are typically described as average values because the synthesis of polymers typically produces a distribution of various individual molecules.

All isomers and chiral options for each compound described herein are expressly contemplated for use herein in various non-limiting embodiments.

Aspects of the invention are directed to a method of vis-breaking a polyolefin comprising: mixing an organic peroxide with an ethylene vinyl acetate (EVA) copolymer to form a first mixture; melt extruding the first mixture from a first extruder at a temperature at least about 10° C. lower, for instance about 12° C. lower, about 14° C. lower, about 16° C. lower, about 18° C. lower or about 20° C. lower, than the half-life time temperature of the organic peroxide and at least about 10° C. higher, for instance about 15° C. higher, about 20° C. higher, about 25° C. higher or about 30° C. higher than the melting point of the EVA copolymer to form an extruded first mixture; pelletizing the extruded first mixture to form a cross-linkable EVA composition; mixing the cross-linkable EVA composition and the polyolefin to form a second mixture; and, melt extruding the second mixture from a second extruder at a temperature of at least about 200° C. In the cross-linkable EVA composition, the organic peroxide is encapsulated in the EVA copolymer. Further, in the extrusion of the second mixture, the organic peroxide decomposes to concurrently and/or simultaneously crosslink the EVA and vis-break the polyolefin.

The polyolefin subjected to the vis-breaking method may preferably be selected from the group consisting of polypropylene homopolymers, polypropylene random copolymers and polypropylene heterophasic copolymers.

In certain embodiments, the polyolefin is a polypropylene random copolymer comprising the reacted units of propylene and, based on the weight of the copolymer, from about 1 to about 30 wt. % of the reacted units of at least one C₄-C₈ 1-olefin (α-olefin) monomer. For example, the polyolefin may be a polypropylene random copolymer comprising the reacted units of propylene and, based on the weight of the copolymer, from about 1 to about 20 wt. %, from about 5 to about 20 wt. % or from about 5 to 15 wt. % of the reacted units of at least one C₄-C₈ 1-olefin monomer.

In certain embodiments, the polyolefin is a polypropylene heterophasic copolymer comprising, based on the weight of the copolymer: at least 70 wt. %, preferably at least 75 wt. % of reacted units of propylene; from 1 to about 30 wt. %, preferably from about 5 to about 20 wt. % of reacted units of ethylene; and, from about 0 to about 5 wt. % of reacted units of at least one C₄-C₈ 1-olefin monomer. Polypropylene heterophasic copolymers may be exemplified by comprising, based on the weight of the copolymer: from about 85 to about 99 wt. % or from about 85 to about 95 wt. % of the reacted units of propylene; from about 1 to about 15 wt. % or from about 5 to about 15 wt. % of the reacted units of ethylene; and, from about 0 to about 5 wt. % of the reacted units of at least one C₄-C₈ 1-olefin monomer.

Exemplary 1-olefins, which may be present either alone or in combination in the polypropylene random copolymers or the polypropylene heterophasic copolymers, include: 2-methylprop-1-ene; 1-butene; 3-methyl-1-butene; 1-pentene; 4-methyl-1-pentene; 3,4-dimethyl-1-butene; 1-hexene; 3-methyl-1-hexene; 1-heptene; and, 1-octene. Preferred olefins, which may be present alone or in combination in the polypropylene random copolymers or the polypropylene heterophasic copolymers, include: 1-butene; 1-pentene; 1-hexene; 1-heptene; and, 1-octene.

In certain embodiments, the polyolefin subjected to the vis-breaking method may have a melt flow rate of from about 1 to about 30 dg/min., as determined at about 230° C. using a 2.16 kg load cell in accordance with ISO 1133. For example, the polyolefin may have a melt flow rate, as determined at about 230° C. using a 2.16 kg load cell in accordance with ISO 1133, of from about 1 to about 25 dg/min., from about 5 to about 25 dg/min or from about 10 to about 25 dg/min.

Alternatively or additionally to the described melt flow rate, the polyolefin subjected to the vis-breaking method may have a melting temperature of from about 100 to about 175° C., as determined at 1 atmosphere (0.1 MPa) pressure. For example, the polyolefin may have a melting temperature of from about 115 to about 175° C., from about 130 to about 175° C. or from about 140 to about 165° C.

In certain embodiments, the polyolefin has a xylene soluble content of less than about 5 wt. %, based on the weight of the polyolefin and as determined by extraction in accordance with ASTM 5492. For example, the polyolefin may have a xylene soluble content of from about 0.1 to about 5 wt. %, from about 0.1 to about 4.0 wt. %, from about 0.1 to about 4.0 wt. % or from 0.5 to about 4.0 wt. %, based on the weight of the polyolefin.

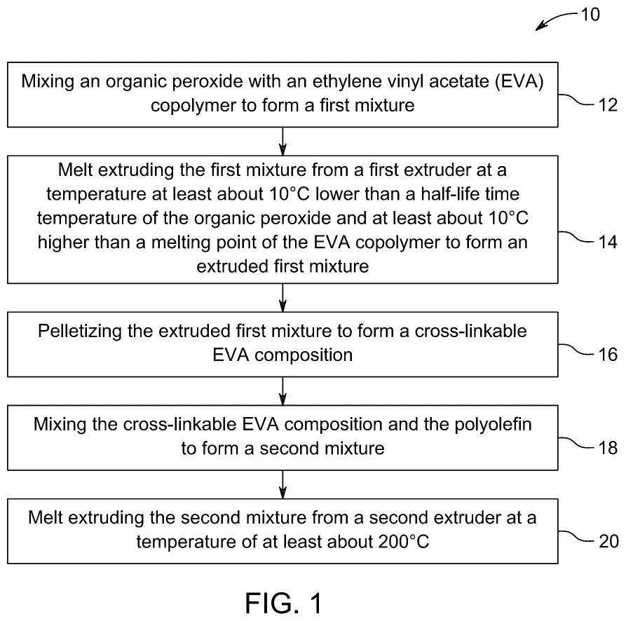

Referring to FIG. 1, step 12 of the illustrated method comprises mixing the organic peroxide with the ethylene vinyl acetate (EVA) copolymer to form the first mixture.

In an embodiment, at least a fraction of the organic peroxide and at least a fraction of the EVA copolymer are separately fed into the first extruder and mixed therein at a temperature at least about 10° C. above the melting point of the copolymer but at least about 10° C. below the half-life time temperature of the organic peroxide.

In another embodiment, which is not mutually exclusive of that above, at least a fraction of the organic peroxide and at least a fraction of the EVA copolymer, preferably the entire amounts of the organic peroxide and the EVA copolymer are mixed—at ambient temperature, for example—prior to being fed into the first extruder. Such mixing prior to introduction of the mixture into the first extruder may occur above or below the melting point of the ethylene vinyl acetate (EVA) copolymer(s) but is preferably performed below said melting point below the half-life time temperature of the organic peroxide.

In step 12, the compounds should be mixed under sufficient forces to yield a homogeneous mixture: this may be achieved through the use of at least one of shear force, extensional force, compressive force, ultrasonic energy, electromagnetic energy or thermal energy. It is considered that such forces can be applied without special conditions or special equipment. However, suitable mixing devices might include: static mixing devices; magnetic stir bar apparatuses; wire whisk devices; augers; batch mixers; planetary mixers; Buss kneaders; Henschel mixers; helicones; Ross mixers; roll mills; C.W. Brabender or Banburry® style mixers; and, high shear mixers, such as blade-style blenders and rotary impellers.

The first mixture obtained in step 12 typically comprises, based on the weight of the first mixture: from about 0.5 to about 5 wt. % of the organic peroxide; and, from about 95 to about 99.5 wt. % of the ethylene vinyl acetate (EVA) copolymer. For example, the first mixture may comprise, based on the weight of the first mixture: from about 0.5 to about 2.5 wt. %, such as from 0.5 to 2.0 wt. % or from 0.5 to 1.5 wt. % of the organic peroxide; and, from 97.5 to 99.5 wt. %, such as from 98.0 to 99.5 wt. % or from 98.5 to 99.5 wt. % of the ethylene vinyl acetate (EVA) copolymer. An exemplary first mixture comprises, based on the weight of the first mixture: about 0.8 to about 1.2 wt. % of the organic peroxide; and, from about 98.8 to about 99.2 wt. % of the ethylene vinyl acetate (EVA) copolymer.

Illustrative organic peroxide compounds suitable for use herein may be selected from the group consisting of: cyclic peroxides; diacyl peroxides; dialkyl peroxides; organic hydroperoxides; monoperoxycarbonates; peroxydicarbonates; monoperoxyesters; diperoxyesters; peroxyketals; and, mixtures thereof. The organic peroxides may be oligomeric or polymeric peroxides but are typically monomeric.

For completeness, organic peroxides which include two or more peroxygen bearing moieties in one molecule—such as two or more groups selected from peroxy groups (—O—O—), peroxy ester groups (—C(O)OO—), peroxy(di)carbonate groups (—OC(O)OO—), peroxyketal groups (—OO—C—OO—) and dicacyl peroxide groups (—C(O)OOC(O)—)— may also have utility in the present disclosure. Important examples of compounds having two peroxygen bearing moieties include: 1,3-bis(t-butylperoxyisopropyl)benzene; 2,5-dimethyl-2,5-di-t-butylperoxyhexane; 2,5-dimethyl-2,5-di-t-butyl-peroxyhex-3-yne; and, 4-methyl-2,2-di-t-butylperoxypentane.

In an embodiment of the invention, the organic peroxide comprises or consists of at least one hydroperoxide compound represented by the Formula (HP1):

R^{p}OOH (HP1)
wherein: R^{p} is an aliphatic or aromatic group containing up to 18 carbon atoms.
   In certain embodiments, R^{p} is C₁-C₁₂ alkyl, C₆-C₁₈ aryl or C₇-C₁₈ aralkyl. Exemplary hydroperoxides in accordance with Formula (HP1) include: cumene hydroperoxide (CHP); para-menthane hydroperoxide; t-butyl hydroperoxide (TBH); t-amyl hydroperoxide; and, 1,2,3,4-tetramethylbutyl hydroperoxide.

In an alternative embodiment, the organic peroxide comprises or consists of at least peroxide compound represented by the Formula (P1)

R^{q}OOR^{r} (P1)
wherein: R^{q} and R^{r} may be the same or different and are independently selected from aliphatic or aromatic groups containing up to 18 carbon atoms.
   In certain embodiments, each of R^{q} and R^{r} is independently C₁-C₁₂ alkyl, C₆-C₁₈ aryl or C₇-C₁₈ aralkyl.

As exemplary peroxide compounds in accordance with Formula (P1), which compounds may be used alone or in combination, there may be mentioned: di-t-butyl peroxide; di-t-amyl peroxide; t-butyl cumyl peroxide; di-t-amyl peroxide; and, dicumyl peroxide.

Examples of (di)peroxyesters, which may be used alone or in combination in the present disclosure, include: 1,1,4,4-tetramethylbutyl-1,4-di(peroxy-2-methylpropanoate); tert-butylperoxy neodecanoate; tert-amylperoxy neodecanoate; 1,1,3,3-tetramethyl butyl-1-peroxy neodecanoate; 1,1-dimethyl-3-hydroxy butyl-1-peroxy neodecanoate; tert-butylperoxy pivalate; tert-amylperoxy pivalate; 1,1,3,3-tetramethyl butyl-1-peroxy pivalate; 1,1-dimethyl-3-hydroxy butyl-1-peroxy pivalate; tert-butylperoxy 2-ethylhexanoate; tert-amylperoxy 2-ethylhexanoate; 1,1,3,3-tetramethyl butyl-1-peroxy 2-ethylhexanoate; 1,1-dimethyl-3-hydroxy butyl-1-peroxy 2-ethylhexanoate; tert-butylperoxy benzoate; tert-amylperoxy benzoate; 1,1,3,3-tetramethyl butyl-1-peroxy benzoate; 1,1-dimethyl-3-hydroxy butyl-1-peroxy benzoate; tert-butylperoxy 3,3,5-trimethylhexanoate; tert-amylperoxy 3,3,5-trimethylhexanoate; 1,1,3,3-tetramethyl butyl-1-peroxy 3,3,5-trimethylhexanoate; 1,1-dimethyl-3-hydroxy butyl-1-peroxy 3,3,5-trimethylhexanoate; t-butyl peroxy-2-hexanoate; tert-butylperoxy isobutyrate; tert-amylperoxy isobutyrate; 1,1,3,3-tetramethyl butyl-1-peroxy isobutyrate; 1,1-dimethyl-3-hydroxy butyl-1-peroxy isobutyrate; and, t-butyl peroxy acetate.

Examples of diacyl peroxides, which may be used alone or in combination in the present disclosure, include: diacetyl peroxide; dibenzoyl peroxide; bis(3,3,5-trimethylhexanoyl) peroxide; dilauroyl peroxide; and, didecanoyl peroxide.

Examples of peroxydicarbonates, which may be used alone or in combination in the present disclosure, include: [di(4-t-butylcyclohexyl) peroxydicarbonate; di(2-ethylhexyl) peroxydicarbonate; dibenzoyl peroxide; dicetyl peroxydicarbonate; and, dimyristyl peroxydicarbonate. Examples of monoperoxycarbonates which may be used alone or in combination in the present disclosure include: t-butylperoxy 2-ethylhexyl carbonate; t-amylperoxy 2-ethylhexyl carbonate; and, t-butylperoxy isopropyl carbonate.

Examples of (cyclic) peroxyketales include 1,1-di(tert-butylperoxy)cyclohexane; 1,1-di(tert-butylperoxy)-3,3,5-trimethylcyclohexane; 2,2-di(4,4-di(tert-butylperoxy) cyclohexyl) propane; and, 3,6,9,-triethyl-3,6,9-trimethyl-1,4,7-triperoxonane.

In an exemplary embodiment of the present disclosure, the organic peroxide is selected from the group consisting of: di-t-butyl-peroxide; t-butyl-cumyl-peroxide (BCUP); dicumyl peroxide; 1,3-bis(t-butylperoxyisopropyl)benzene; 2,5-dimethyl-2,5-di-t-butylperoxyhexane; 2,5-dimethyl-2,5-di-t-butyl-peroxyhex-3-yne; 4-methyl-2,2-di-t-butylperoxypentane; and, t-butylperoxy 2-ethylhexyl carbonate. In another exemplary embodiment, the organic peroxide is selected from the group consisting of: dicumyl peroxide; 2,5-dimethyl-2,5-di-t-butylperoxyhexane; and, t-butylperoxy 2-ethylhexyl carbonate.

Exemplary commercial organic peroxides having utility in the present method include: Luperox DC, Luperox Di, Luperox 101, Luperox 130 and Luperox 801, available from Arkema; Perkadox 14S, available from Nouryon; and, Trigonox B, Trigonox T, Trigonox 101 and Trigonox 145, available from Nouryon.

An ethylene vinyl acetate (EVA) copolymer is a copolymer that is obtained via the co-polymerization of ethylene and vinyl acetate monomers. In the present disclosure, the reacted units of ethylene may constitute the majority of the monomer units of the ethylene vinyl acetate copolymer. The ethylene vinyl acetate copolymer may conventionally comprise, based on a total weight of the EVA copolymer: from about 60 to about 90 wt. % of the reacted units of ethylene; and, about 10 to about 40 wt. % of the reacted units of vinyl acetate. For example, the EVA copolymer may comprise, based on a total weight of the EVA copolymer: from about 65 to about 90 wt. % of the reacted units of ethylene; and, from 10 to about 35 wt. %. In a further example, the EVA copolymer may comprise, based on a total weight of the EVA copolymer: from about 70 to about 90 wt. % of the reacted units of ethylene; and, or from about 10 to about 30 wt. % of the reacted units of vinyl acetate. The percentage by weight of vinyl acetate can be determined on an “as added” monomer basis, based on the synthesis of the ethylene vinyl acetate copolymer. In the alternative, the percentage by weight of vinyl acetate may be determined post-synthesis by, for instance: gravimetric analysis; quantitative Fourier Transform Infrared spectroscopy; or, nuclear magnetic resonance.

In a further embodiment, which is not intended to be mutually exclusive of the compositional ranges mentioned above, ethylene vinyl acetate copolymer may conventionally have a melt flow rate of from about 1 to about 40 dg/min., as determined at 230° C. using a 2.16 kg load cell in accordance with ISO 1133. For example, the ethylene vinyl acetate copolymer may have a melt flow rate of from about 1 to about 30 dg/min, or from about 1 to about 25 dg/min. as determined at 230° C. using a 2.16 kg load cell in accordance with ISO 1133.

EVA copolymer included in the first mixture in step 12 may, in certain embodiments, be exemplified by a weight average molecular weight (Mw) of from about 20 to about 200 kilodaltons (kDa), for instance from about 50 to about 200 kDa or from about 50 to about 150 kDa.

As depicted in steps 14 and 16 of FIG. 1, the obtained mixture of the ethylene vinyl acetate copolymer and the organic peroxide is subjected to melt extrusion and pelletizing of the extruded product. The melt extrusion is performed at a temperature (Tₘ₁) at least about 10° C. lower than the half-life time temperature of the organic peroxide and at least about 10° C. higher than the melting point of the EVA copolymer. The reason for the close control of the temperature of the first melt extrusion step 14, and where applicable the mixing step 12 is to limit or prevent the crosslinking of the ethylene vinyl acetate copolymer in the first mixture. This crosslinking is undesired at these steps of the method: the extrudate should retain crosslinkable ethylene vinyl acetate.

Crosslinking of ethylene vinyl acetate copolymer may occur via a radical reaction, wherein the organic peroxide of the first mixture can act as a radical initiator. Homolytic cleavage of the organic peroxide-under thermal activation (thermolysis)—would form two radical species, which then abstract hydrogen from the ethylene vinyl acetate copolymer chains, in particular from the terminal methyl groups of the vinyl acetate side-chains. In this process, the active radical site is transferred to the methyl group, which then reacts with another active site in its vicinity, creating a chemical bond between the polymer chains. The native ethylene vinyl acetate copolymer is plastically deformable and mildly opaque: crosslinking of the ethylene vinyl acetate during the mixing 12 or first extrusion step 14 would conversely form an undesired, transparent, 3-dimensional polymeric network which is characterized by high mechanical and thermal stability.

The temperature of the first extrusion step 14 can inhibit or prevent thermolysis of the organic peroxide. Without being bound by theory, the homolytic cleavage of the organic peroxide is rate limiting of the reaction kinetics of the crosslinking reaction where the ethylene vinyl acetate copolymer is provided in significant weight excess to the organic peroxide.

Melt extrusion 14 can be performed with a melt extruder which can possess a single screw or multiple screws: the provision of more than one screw may be advantageous in providing mechanical energy and for conveying, mixing and compressing the provided mixture. Where a multiple screw extruder is used, the constituent screws may be co-rotational or, alternatively, counter-rotational where high shear forces are required.

The first mixture is introduced to the first extruder at a feed zone and at a desired feed rate. Upon introduction, air tends to be entrained in that mixture: that air can be removed by a vacuum device connected to the cylindrical barrel of the extruder. The friction between that cylindrical barrel of the extruder, the (optionally degassed) molten mixture and the rotating screw(s) provide the driving force for the molten mixture to reach the die through which it is extruded.

The rotational velocity of the or each screw of the hot-melt extruder can affect the quality of the extrudate. For example, if the rotation speed of a screw is too low, the retention time of the mixture in the extruder may be lengthened unnecessarily. Conversely, if the rotation speed of the or each screw is too fast relative to the feed rate of the molten mixture, a porous extrudate can be produced. In the present disclosure, the melt extrusion 14 may be exemplified by at least one condition selected from the group consisting of: i) a rotational velocity of the or each screw of from about 25 to about 250 revolutions per minute (rpm), for example from about 50 to about 200 rpm; ii) a retention time of the molten mixture in the extruder of from about 0.1 to about 5 minutes, for example from about 0.1 to about 2 minutes; iii) a feed rate of the molten mixture to the extruder of from about 1 to about 30 kg/hour, for example from about 5 to about 20 kg/hour; and, iv) an extruder pressure of from about 1 to about 20 MPa, for example from about 5 to about 10 MPa. For surety, these conditions i) to iv) are not mutually exclusive and one, two, three or four thereof may be applicable.

Through using at least one heating device and, where appropriate, at least one cooling device, the temperature (Tₘ₁) across the entire length of the first extruder—thus including the feed zone and the die thereof—should be maintained at a value at least about 10° C. lower than the half-life time temperature of the organic peroxide but at least about 10° C. higher than the melting point of the EVA copolymer. This requirement does not, however, preclude the first extruder from comprising a sequence of zones of which the temperatures are independently controlled. Thus, where the first extruder is to be maintained at a temperature of from about 80 to about 120° C. through its entire length for example, that first extruder may comprise a first zone in which the temperature is maintained in the range of from about 80 to about 90° C., and a second zone in which the temperature is maintained in the range of from 95 to 105° C. The temperature of the feed zone and the temperature of the die may also be independently controlled, conventionally such that these distal regions are at a lower temperature than the central zone(s) of the extruder.

The molten material which has passed through the cylindrical cavity of the first extruder is delivered through the die cavity to the die head which will conventionally be of fixed diameter and possess either a circular or polygonal shape. In certain embodiments, the die head may have a diameter of from about 0.1 to about 10 mm, for instance from about 0.1 to about 5 mm. To ensure uniformity of the extrudate, the diameter of the extrudate at the die head may be measured using an inline laser, for example.

Whilst the extrudate from the first extruder may be provided as strand or a sheet—which may subsequently be cut after cooling using a dedicated cutting device—it is more typical for the molten extrudate from the first extruder to be subjected to die-face pelletization prior to cooling. In this embodiment, a rotating blade disposed at the die face cuts the extrudate: the rate of extrusion, the geometry of the die head, the geometry of the blade and the rotational velocity of the blade may be determinative of the shape and size of the pellets so obtained.

The cooling of the extrudate can be effected by contacting the extrudate with a gas stream or with a cold surface. As ethylene vinyl acetate is a crystalline polymer, it will possess a very sharp solidification point. The cooling rate may be determinative of the crystallinity of the product: rapid cooling would lead to the formation of small crystals whereas annealing would result in additional crystal growth. A skilled artisan may thereby control crystal size through varying inter alia the throughput rate of the extrudate and the temperature of the cooling medium.

There is no particular intention to limit the shape of the pelletized extrudate obtained in step 16 of FIG. 1: it is envisaged that pellets may possess cylindrical, spherical, oval, disc, cubic, rectangular or other polyhedral shapes. In an embodiment, the pellets may be exemplified by a median particle diameter of from about 5 to about 5000 μm, for example from about 5 to about 1000 μm or about 5 to about 500 μm. When the size of pellet is smaller than about 5 μm, some pellet loss may occur due to the electrostatic forces. When the median particle diameter is larger than about 5000 μm, this may be inconvenient to the subsequent administration of that pellet.

The product extruded from the first extruder and which is pelletized in step 16 of the method of FIG. 1 is an crosslinkable ethylene vinyl acetate composition in which the organic peroxide is encapsulated in the ethylene vinyl acetate copolymer. As discussed above, the crosslinkability of the ethylene vinyl acetate copolymer may be inferred from the retention of some opacity in the cooled extrudate of the first extruder.

As recognized in the art, the gel content of the ethylene vinyl acetate composition may be determined to provide an indirect measure of the degree of crosslinking of the ethylene vinyl acetate copolymer: a lower gel content of the ethylene vinyl acetate composition is indicative of a lower degree of crosslinking in the copolymer. In certain embodiments, the crosslinkable ethylene vinyl acetate composition obtained in step 16 of the illustrated method may have a gel content of from about 60 to about 95%, as determined in accordance with ASTM D 2765. For example, the crosslinkable ethylene vinyl acetate composition may have a gel content of from about 65 to about 95%, from about 70 to about 95%, from about 75 to about 95%, from about 80 to about 95%, from about 85 to about 95% or from about 88 to about 92%.

In the composition obtained in step 16, the encapsulation of the organic peroxide by the ethylene vinyl acetate copolymer may be further verified by thermogravimetric analysis (TGA) under an inert atmosphere. An ethylene vinyl acetate copolymer itself would conventionally have a thermogravimetric profile which has two major degradation steps: a first step, which commences in the temperature range of from about 300 to 375° C. and which is attributable to the removal of the constituent acetate groups; and, a second step in the temperature range of from about 425 to about 475° C. which is attributable to the degradation of the polyethylene backbone of the copolymer. The ethylene vinyl acetate composition of step 16 will conventionally exhibit, in the thermogravimetric analysis, a degradation at a temperature lower than the aforementioned first step and which is attributable to the thermal decomposition of the encapsulated organic peroxide.

The encapsulation of the organic peroxide in the ethylene vinyl acetate copolymer may serve to subsequently reduce the compounding force necessary to mix—in the molten state—these components with the polyolefin, as compared to the mixing of these components independently with the polyolefin in the molten state. A reduction in such compound force may present an energetic benefit in that less power is required to effect such compounding.

Referring back to FIG. 1, steps 18 and 20 comprise, respectively, mixing the cross-linkable EVA composition and the polyolefin to form a second mixture; and, melt extruding the second mixture from a second extruder at a temperature of at least about 200° C. In an embodiment, at least a fraction of the pelletized EVA composition and at least a fraction of the polyolefin are separately fed into the second extruder and mixed therein at a temperature above at the temperature of at least about 200° C. In another embodiment, which is not mutually exclusive of that above, at least a fraction of the pelletized EVA composition organic peroxide and at least a fraction of the polyolefin are mixed prior to being fed into the second extruder.

The presence of adjuncts in the second mixture in addition to the crosslinkable EVA composition and the polyolefin is not precluded. For instance, the adjuvants may impart one or more of: improved fracture toughness; improved elastic properties; improved elastic recovery; longer enabled processing time; and, modified curing times for the crosslinkable ethylene vinyl acetate composition. Included among such adjuvants are: cure retarders; plasticizers; stabilizers, including antioxidants; moisture scavengers; colorants; rheology control agents; and, flame retardants. Such adjuvants should typically not constitute a supplementary source of free radicals under thermolysis at the temperature of the second extruder or possess functional groups capable of undergoing a radical addition reaction. Further, in an embodiment, the second mixture is substantially free of polyolefin which has been modified with maleic anhydride.

Such adjuvants can be used in such combination and proportions as desired, provided they do not adversely affect the nature and essential properties of the second mixture and of the visbroken composition obtained therefrom. While exceptions may exist in some cases, these adjuvants preferably do not in toto comprise more than about 5 wt. % and preferably should not comprise more than about 1 wt. % or more than about 0.5 wt. % the second mixture, based on the total weight of that mixture.

Such mixing 18 prior to introduction of the second mixture into the second extruder may occur above or below the melting point of the polyolefin but is preferably performed above said melting point. That aside, the materials should be mixed under sufficient forces to yield a homogeneous mixture, effected by the use of at least one of shear force, extensional force, compressive force, ultrasonic energy, electromagnetic energy or thermal energy. It is considered that such forces can be achieved without special conditions or special equipment. However, suitable mixing devices might include: static mixing devices; magnetic stir bar apparatuses; wire whisk devices; augers; batch mixers; planetary mixers; Buss kneaders; Henschel mixers; helicones; Ross mixers; roll mills; C.W. Brabender or Banburry® style mixers; and, high shear mixers, such as blade-style blenders and rotary impellers.

The second mixture should typically comprise, based on the weight of the second mixture: from about 5 to about 20 wt. % of the cross-linkable EVA composition; and, from about 80 to about 95 wt. % of the polyolefin. For example, the second mixture may comprise, based on the weight of the mixture: from about 5 to about 15 wt. % or from about 8 to about 12 wt. % of the cross-linkable EVA composition; and, from about 85 to about 95 wt. % or from about 88 to about 92 wt. % of the polyolefin.

In step 20, the second mixture of the cross-linkable EVA composition and the polyolefin is subjected to melt extrusion and, optionally, pelletizing of the extruded product. Melt extrusion can be performed with a melt extruder which can possess a single screw or multiple screws: the provision of more than one screw may be advantageous in providing mechanical energy and for conveying, mixing and compressing the provided mixture. Where a multiple screw extruder is used, the constituent screws may be co-rotational or, alternatively, counter-rotational where high shear forces are required.

The second mixture is introduced to the second extruder at a feed zone and at a desired feed rate. Upon introduction, air may tend to be entrained in that mixture. Whilst that air can be removed by a vacuum device connected to the cylindrical barrel of the extruder, in certain embodiments such entrained air is permitted to remain in the extruder as this may contribute to oxidative chain scission of the polyolefin. The friction between that cylindrical barrel of the extruder, the (optionally degassed) molten mixture and the rotating screw(s) provide the driving force for the molten mixture to reach the die through which it is extruded.

The rotational velocity of the or each screw of the melt extruder can affect the quality of the extrudate. For example, if the rotation speed of a screw is too low, the retention time of the mixture in the extruder may be lengthened unnecessarily. Conversely, if the rotation speed of the or each screw is too fast relative to the feed rate of the molten mixture, a porous extrudate can be produced. In the present disclosure, the melt extrusion 20 in the second extruder may be exemplified by at least one of the following conditions: i) the rotational velocity of the or each screw of from about 25 to about 250 revolutions per minute (rpm), for example from about 50 to about 200 rpm; ii) the retention time of the molten mixture in the second extruder is from about 20 to about 400 seconds, for example from about 30 to about 300 second; iii) the feed rate of the molten mixture to the second extruder is from about 1 to about 30 kg/hour, for example from about 5 to about 20 kg/hour; iv) the extruder pressure is from about 1 to about 20 MPa, for example from about 5 to about 10 MPa; and, v) the specific energy input to the second extruder is from about 0.1 to 1 kWh/kg, for example from 0.1 to 0.5 kWh/kg, based on the weight of the second mixture. These conditions i) to iv) are not mutually exclusive and one, two, three or four thereof may be applicable.

Through using at least one heating device and, where appropriate, at least one cooling device, the temperature across of the entire length of the second extruder—thus including the feed zone and the die thereof—is preferably maintained within the range of at least 200° C., for example from 200 to 300° C. or, desirably, from about 200 to 250° C. This requirement does not, however, preclude the first extruder from comprising a sequence of zones of which the temperatures are independently controlled. Thus, for example, the first extruder may comprise a first zone in which the temperature is maintained in the range of from about 200 to about 220° C., and a second zone in which the temperature is maintained in the range of from about 220 to about 250° C. The temperature of the feed zone and the temperature of the die may also be independently controlled, conventionally such that these distal regions are at a lower temperature than the central zone(s) of the extruder.

The temperature of the second extruder is controlled at a temperature above both the melting point of the ethylene vinyl acetate (EVA) copolymer and above the half-life temperature of the organic peroxide encapsulated within the EVA copolymer. As such, that organic peroxide will undergo thermolysis in the second extruder: the generation of free radicals by homolytic cleavage of the organic peroxide serves both to crosslink the ethylene vinyl acetate by the mechanism discussed above. Moreover, the free radicals concurrently initiate chain scission of the polyolefin present in the molten second mixture to visbreak that polyolefin.

The molten material which has passed through the cylindrical cavity of the second extruder is delivered through the die cavity to the die head which will conventionally be of fixed diameter and possess either a circular or polygonal shape. In certain embodiments, the die head may have a diameter of from about 0.1 to about 10 mm, for instance from about 0.1 to about 5 mm. To ensure uniformity of the extrudate, the diameter of the extrudate at the die head may be measured using an inline laser, for example.

Whilst the extrudate from the second extruder may be provided as strand or sheet—which may subsequently be cut after cooling using a dedicated cutting device—it is more typical for the molten extrudate from the first extruder to be subjected to die-face pelletization prior to cooling. In this embodiment, a rotating blade disposed at the die face cuts the extrudate: the rate of extrusion, the geometry of the die head, the geometry of the blade and the rotational velocity of the blade may be determinative of the shape and size of the pellets so obtained.

The cooling of the extrudate can be effected by contacting the extrudate with a gas stream or with a cold surface. Where the polyolefin is a crystalline polymer, it will possess a very sharp solidification point. The cooling rate may be determinative of the crystallinity of the product: rapid cooling may lead to the formation of small crystals whereas annealing may result in additional crystal growth. A skilled artisan may thereby control crystal size through varying inter alia the throughput rate of the extrudate and the temperature of the cooling medium.

Where pelletization is performed of the extrudate of step 20, there is no particular intention to limit the shape of the pelletized extrudate: it is envisaged that pellets may possess cylindrical, spherical, oval, disc, cubic, rectangular or other polyhedral shapes. In an embodiment, the pellets may be exemplified by a median particle diameter of from about 5 to about 5000 μm, for example from about 5 to 1000 μm or about 5 to about 500 μm. When the size of pellet is smaller than 5 μm, some pellet loss may occur due to the electrostatic forces. When the median particle diameter is larger than 5000 μm, this may be inconvenient to the subsequent administration of that pellet.

In certain embodiments, the composition comprising a crosslinked EVA and a vis-broken polyolefin obtained at step 20 of the present method may have: a melt flow rate of at least about 50 dg/min, as determined at about 230° C. using a 2.16 kg load cell in accordance with ISO 1133. For example, the obtained composition may have a melt flow rate, as determined at about 230° C. using a 2.16 kg load cell in accordance with ISO 1133 of from about 60 to about 120 dg/min, from about 70 to about 120 dg/min, from about 80 to about 120 dg/min, from about 90 to about 120 dg/min or from about 100 to about 120 dg/min.

In an alternative embodiment, which is not intended to be mutually exclusive of the melt flow rates described above, the method of the present disclosure may provide a vis-breaking ratio of at least about 4. For example, the method may be exemplified by a vis-breaking ratio of from about 4.0 to about 6.0, from about 4.4 to about 6.0, from about 4.6 to about 6.0 or from about 4.8 to about 6.0.

In certain embodiments, the composition comprising a crosslinked EVA and a vis-broken polyolefin obtained at step 20 of the present method may have at least one of: a) a tensile modulus of at least about 800 MPa, for example at least about 850 MPa or at least about 875 MPa; b) a strain-at-break of from about 3 to about 15%, for example a strain-at-break of from about 4 to about 12% or from about 5 to about 10%; and, c) a toughness of at least about 500 KJ/m³, for example at least about 550 KJ/m³ or at least about 575 KJ/m³. The properties a) to c) are not intended to be mutually exclusive and, as such, the composition may meet one, two or three thereof.

The vis-breaking of the polyolefin with the encapsulated pro-degradant of the present method may serve to yield a vis-broken product having at least one of: a reduced tensile modulus; an increased strain-at-break; and, increased toughness, when compared to a vis-broken polyolefin prepared using the same pro-degradant in un-encapsulated form.

The following examples are illustrative of the present invention and are not intended to limit the scope of the invention in any way.

### EXAMPLES

The following materials were employed in the Examples:
Luperox® 101:2,5-dimethyl-2,5-di(tert-butylperoxy)-hexane having a half-life temperature (1 hour) of 138° C., available from Arkema.
EVA6022 CO: Ethylene vinyl acetate copolymer resin (22 wt. % vinyl acetate), available from Sipchem, Kingdom of Saudi Arabia.
HECO PP C190HM: Heterophasic propylene copolymer having a melt flow rate of 19 dg/min, as determined at a temperature of 230° C. with a load of 2.16 kg, available from Sipchem, Kingdom of Saudi Arabia.

### Synthesis Example 1

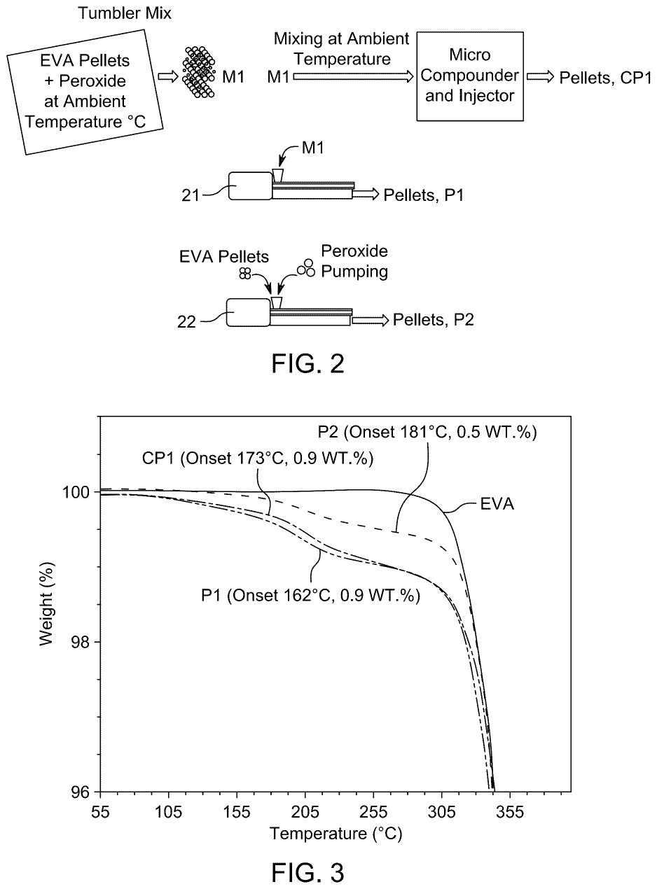

Referring to FIG. 2, a mixture (M1) was obtained by combining in a tumbler mixer pellets of ethylene vinyl acetate (EVA6022CO) and the organic peroxide (Luperox® 101) at a ratio by weight of 99:1 at a temperature of 25° C. and a relative humidity of 50%.

A first fraction of that mixture (M1) was then fed directly into a micro-compounder and formed into comparative pellets (CP1) which comprise ethylene vinyl acetate and said organic peroxide in simple admixture.

A second fraction of that mixture (M1) was added to the feeder of a twin-screw melt extruder (21) and subjected to melt extrusion and die-face pelletization to form pellets (P1) in which the organic peroxide is encapsulated in the ethylene vinyl acetate. The melt extruder (21) comprised a feed zone, a die and nine (9) barrel zones interposed sequentially between the feed zone and the die and of which the temperature could be independently regulated. The melt extruder (21) was characterized by: a feed zone temperature of 15° C.; a first barrel zone having a temperature of 90° C.; second to ninth barrel zones each having a temperature of 100° C.; and, a die temperature of 100° C. Further operating parameters of the melt extruder (21) included: a screw speed of 120 revolutions per minute; a motor torque of 75%; a melt temperature of 102° C.; a melt pressure of 6.2 MPa; and, a total feed rate of 15 kg/hour.

With further reference to FIG. 2, pellets (P2) were obtained by separately feeding pellets of ethylene vinyl acetate (EVA6022CO) and organic peroxide (Luperox 101) at a ratio by weight of 99:1 into the feeder of a twin screw extruder (22) and subjecting the combined feed to melt extrusion and die-face pelletization. The melt extruder (22) comprised a feed zone, a die and nine (9) barrel zones interposed sequentially between the feed zone and the die and of which the temperature could be independently regulated. The melt extruder (22) was characterized by: a feed zone temperature of 22° C., a first barrel zone having a temperature of 90° C.; second to ninth sequential barrel zones each having a temperature of 100° C.; and, a die temperature of 100° C. Further operating parameters of the melt extruder (22) included: a screw speed of 120 revolutions per minute; a motor torque of 62%; a melt temperature of 106° C.; a melt pressure of 5.6 MPa; and, a total feed rate of 15 kg/hour.

A summary of Synthesis Example 1 is provided in Table 1 herein below:

TABLE 1
Synthesized

| Ethylene Vinyl | Composition (wt. %) | | |
|---|---|---|---|
| Acetate | | Luperox | |
| Composition | EVA6022CO | 101 | Preparation Conditions |
| CP1 | 99.0 | 1.0 | Simple pelletization of mixture M1; mixing of |
| | | | constituents by adsorption |
| P1 | 99.0 | 1.0 | Melt extrusion (100 °C) of the mixture M1 provided |
| | | | to a twin screw extruder; pelletization of the extrudate |
| P2 | 99.0 | 1.0 | Melt extrusion (100 °C) of a mixture formed in situ |
| | | | within the twin screw extruder following the separate |
| | | | feeding of the ethylene vinyl acetate and peroxide |
| | | | into the extruder at the stated proportion by weight; |
| | | | pelletization of the extrudate. |

### Example 1

Peroxide decomposition of the pellets (CP1, P1 and P2) was investigated by Thermogravimetric Analysis (TGA). Samples of each pellet were independently heated from room temperature to 750° C. under a nitrogen atmosphere and at a ramp rate of 20° C. per minute. Further, a sample of EVA6022CO was independently subjected to the same heating profile.

The results of the TGA are presented in FIG. 3 appended hereto. Pellets P1 exhibited an earlier onset temperature (106.5° C.) than P2 and CP1. It is considered that formulations of which the organic peroxide exhibits an earlier onset degradation temperature are likely to provide more significant viscosity reduction when employed as pro-degradant. It also infers a lower energetic cost to the thermolysis of the organic peroxide.

### Example 2

The Gel Content of the pellets (CP1, P1 and P2) was determined by solvent extraction according to ASTM D 2765 Standard Test Methods for Determination of Gel Content and Swell Ratio of Crosslinked Ethylene Plastics. Samples weighing approximately 1 g were cut from different sections of the first extrudate and transferred to a glass bottle containing 100 mL of xylene: the exact initial weight of each sample (m₀) was determined on a precision balance. The bottle was placed inside an oven set at 110° C. for a 12 hour extraction time. After completing the extraction time, the insoluble residues were dried at 110° C. for 8 hours and the net weight (mₙ) determined. The gel content percent, which is directly related to crosslinking density, was calculated according to: Gel content=(mₙ/m₀)*100%.

The results of the Gel Content testing are provided in Table 2 below:

TABLE 2

| Synthesized Ethylene Vinyl | |
|---|---|
| Acetate Composition | Gel Content (%) |
| CP1 | 90.0 |
| P1 | 90.3 |
| P2 | 91.5 |

A lower gel content of an ethylene vinyl acetate composition is indicative of a lower degree of crosslinking in the copolymer. Each sample indicates that the ethylene vinyl acetate copolymer present in the composition remains crosslinkable.

### Synthesis Example 2

In accordance with the compositional ranges of Table 3 herein below, the pelletized ethylene vinyl acetate composition prepared as the extrudates of Synthesis Example 1 (P1, P2), and the comparative pelletized ethylene vinyl acetate composition prepared without extrusion (CP1), were independently fed into DSM Xplore Micro-compounder MC15 simultaneously with HECO PP C190HM. The micro-compounder was set at a temperature of 220° C. and a rotation speed of 100 revolutions per minute.

TABLE 3

| | | Comparative | Composi- | Composi- |
|---|---|---|---|---|
| | | Composition | tion 1 | tion 2 |
| Ingredient | | (wt. %) | (wt. %) | (wt. %) |
| HECO PP C190HM | | 90.0 | 90.0 | 90.0 |
| Synthesized | CP1 | 10.0 | | |
| Ethylene Vinyl | P1 | | 10.0 | |
| Acetate Composition | P2 | | | 10.0 |

### Example 3

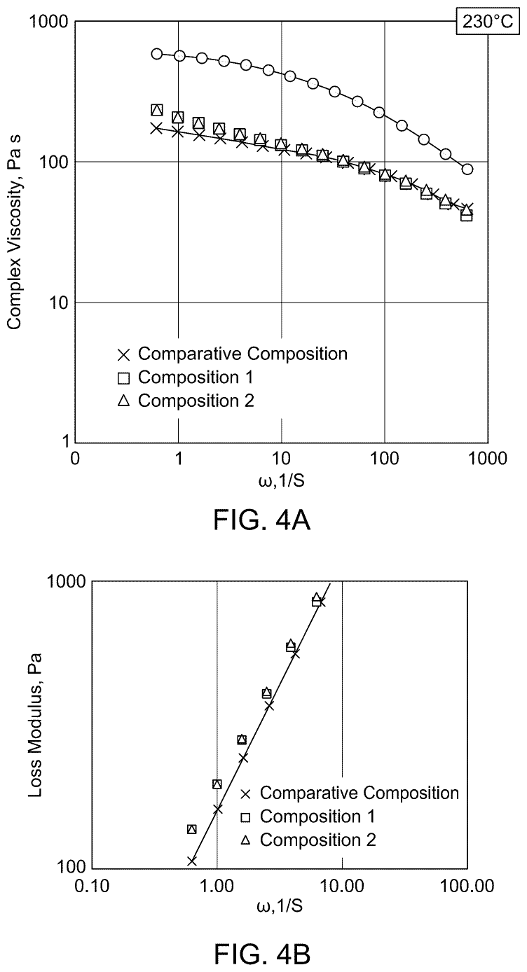

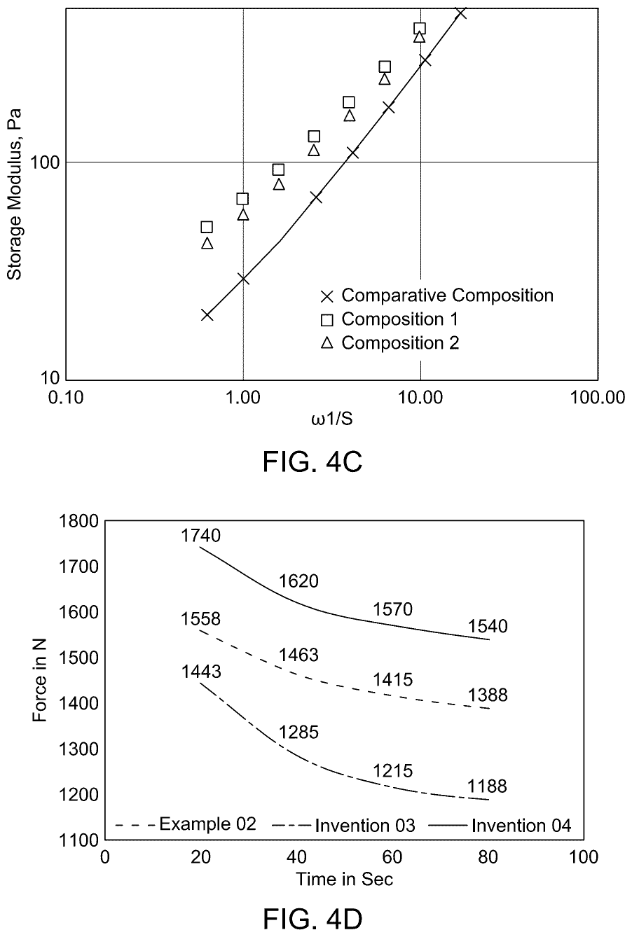

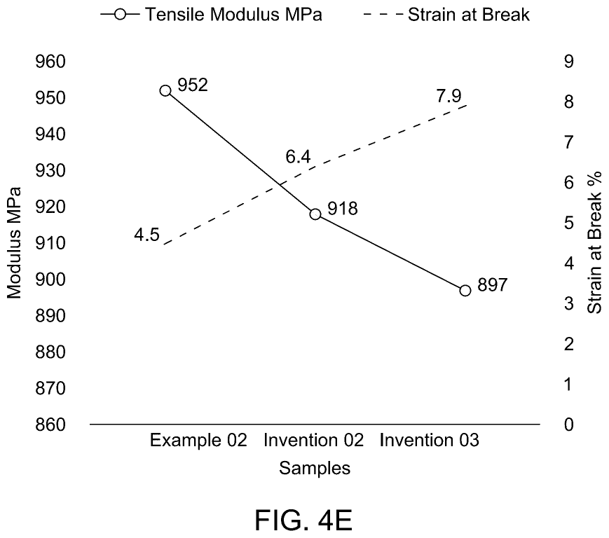

During the micro-compounding, the force response was recorded to evaluate the progressive vis-breaking of the HECO PP C190HM. The recorded force response is provided in Table 4 below and is graphically represented in FIG. 4D appended hereto. After processing the material in the micro-compounder, each material was transferred to a Xplore Micro Injector IM12 and extruded at 220° C. into specimens for, respectively, melt flow rate testing, tensile testing and rheological testing.

Melt Flow Rate (MFR): This parameter was determined using a ZwickRoell extrusion plastometer at a temperature of 230° C. with a load of 2.16 kg in accordance ISO 1133-1: Plastics—Determination of the melt mass-flow rate (MFR) and melt volume-flow rate (MVR) of thermoplastics. The results thereof are provided in Table 4 below.

TABLE 4

| | | Comparative | Composi- | Composi- |
|---|---|---|---|---|
| Property | | Composition | tion 1 | tion 2 |
| Compounding | 20 seconds | 1558 | 1443 | 1740 |
| Force (N) at | 40 seconds | 1463 | 1285 | 1620 |
| Elapsed Time | 60 Seconds | 1415 | 1215 | 1570 |
| | 80 Seconds | 1388 | 1188 | 1540 |

| | | | |
|---|---|---|---|
| Reduction in Measured | 12.2 | 17.7 | 11.5 |
| Compounding Force (%) | | | |
| Melt Flow Rate (dg/min.) | 117.2 | 116.0 | 103.8 |
| Vis-breaking Ratio | 5.5 | 5.4 | 4.9 |

Based on the melt flow rate of the provided heterophasic propylene copolymer (HECOPP C190HM, 19 dg/min), vis-breaking ratios of at least 4.9 were observed for each of Composition 1, Composition 2 and the Comparative Composition.

During micro-compounding, a reduction in force was observed for each composition. Composition 1 demonstrated lower resistance to force as compared to both Composition 2 and the comparative composition. As the force applied to a composition is directionally proportional to power applied to generate a rotational torque in the micro-compounder, the lower force resistance of Composition 1 may permit that composition to be subjected to vis-breaking with lower applied power and thereby lower energetic cost.

### Example 4: Rheological Testing

The behavior of the materials under oscillatory shear was determined using an Anton Paar rotational rheometer at 230° C. and performing a frequency sweep of from 100 Hz to 0.1 Hz. FIGS. 4A to 4C appended hereto plot, against the frequency and respectively: the complex viscosity (Pa·s); loss modulus ((G″)); and, the storage modulus ((G′, Pa)) of the materials. Based on these Figures viewed together, there are evident differences in the rheology of Comparative Composition 1, Composition 1 and Composition 2, suggesting a difference in the molecular weight distribution of the vis-broken polypropylene copolymers.

Referring to FIG. 4A, a reduction of the complex viscosity is observed with increasing shear rate. FIGS. 4B and 4C indicate that Composition 1 and Composition 2 have greater loss and storage moduli than the Comparative Composition: this may be indicative of higher melt strength. Achieving a higher melt strength points to a potential utility of the visbroken compositions in melt-extrusion and thermoforming applications.

### Example 5: Tensile Testing

Tensile testing was performed in accordance with EN ISO 527-1 Plastics-Determination of tensile properties using specimens of type 1B geometry. The results of the testing are provided in Table 5 below. The modulus and strain at break of the tested samples are also illustrated graphically in FIG. 4E appended hereto.

TABLE 5

| | Comparative | | |
|---|---|---|---|
| Property | Composition | Composition 1 | Composition 2 |
| Tensile Modulus (MPa) | 952 | 918 | 897 |
| Strain at Break (%) | 4.5 | 6.4 | 7.9 |
| Toughness (kJ/m³) | 396 | 576 | 711 |

The compositions (1, 2) according to the present disclosure demonstrate a reduced tensile modulus and an increased strain at break as compared to the comparative example: this is considered to be indicative that the examples would provide an improved impact performance. The calculated toughness of Compositions 1 and 2—which both exceed that of the comparative composition-supports this consideration.

Referring to FIG. 4D appended hereto, the force response may be interpreted as a measure of the melt viscosity or the molecular weight of the polypropylene over time during the vis-breaking process: a higher force value indicated in the y-axis infers a higher viscosity or larger molecular chain of the polypropylene. As vis-breaking proceeds, peroxide present in the Composition 1, Composition 2 and the comparative composition (CC1) causes chain scission, leading to a decrease in molecular weight and thereby to a reduction in melt viscosity as indicated by a force reduction. The most effective reduction of the molecular weight and of the viscosity of the polypropylene within the stated timeframe is observed for Composition 1: the lowest initial force and most substantial force decrease over time is observed from this composition. Composition 2 also demonstrates a greater reduction in force over the stated time than Comparative Composition 1 (CC1). The extensive chain scission during vis-breaking of Composition 1 and Composition 2 is considered to result in a lower average molecular weight and a narrower molecular weight distribution in the final processed materials. A lower molecular weight generally leads to a lower stiffness, as observed for both Composition 1 and Composition 2 in FIG. 4E appended hereto.

It can be understood that various changes and modifications to the exemplary embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it can be appreciated that the features of the dependent claims may be embodied in the compositions and methods of each of the independent claims.

Many modifications to and other embodiments of the disclosure set forth herein will come to mind to one skilled in the art to which this disclosure pertains, once having the benefit of the teachings in the foregoing description. Therefore, it is understood that the disclosure is not limited to the specific embodiments disclosed, and that modifications and other embodiments are intended to be included within the scope of the appended claims.

1. A method of vis-breaking a polyolefin, comprising:
mixing an organic peroxide with an ethylene vinyl acetate (EVA) copolymer to form a first mixture;
melt extruding the first mixture from a first extruder at a temperature at least about 10° C. lower than the half-life time temperature of the organic peroxide and at least about 10° C. higher than the melting point of the EVA copolymer to form an extruded first mixture;
pelletizing the extruded first mixture to form a cross-linkable EVA composition;
mixing the cross-linkable EVA composition and the polyolefin to form a second mixture; and,
melt extruding the second mixture from a second extruder at a temperature of at least about 200° C.,
wherein:
in the cross-linkable EVA composition the organic peroxide is encapsulated in the EVA copolymer, and
in the extruding of the second mixture the organic peroxide decomposes to concurrently crosslink the EVA and vis-break the polyolefin thereby forming a composition comprising a crosslinked EVA and a vis-broken polyolefin.

2. The method according to claim 1, wherein the polyolefin is selected from the group consisting of a polypropylene homopolymer, a polypropylene random copolymer and a polypropylene heterophasic copolymer.

3. The method according to claim 1, wherein the polyolefin is a polypropylene random copolymer comprising, based on the weight of the copolymer, from about 1 to about 20 wt. % of reacted units of at least one C₄-C₈ 1-olefin monomer.

4. The method according to claim 1, wherein the polyolefin is a polypropylene heterophasic copolymer comprising, based on the weight of the copolymer:
from about 80 to about 99 wt. % of the reacted units of propylene;
from about 1 to about 20 wt. % of reacted units of ethylene; and,
from about 0 to about 5 wt. % of reacted units of at least one C₄-C₈ 1-olefin monomer.

5. The method according to claim 1, wherein the polyolefin has a melt flow rate of from about 1 to about 30 dg/min. as determined at about 230° C. using an about 2.16 kg load cell in accordance with ISO 1133.

6. The method according to claim 1, wherein the polyolefin has a melt flow rate of from about 1 to about 25 dg/min. as determined at about 230° C. using an about 2.16 kg load cell in accordance with ISO 1133.

7. The method according to claim 1, wherein the polyolefin has a melting temperature of from about 100 to about 175° C.

8. The method according to claim 1, wherein the polyolefin has a xylene soluble content of less than about 5 wt. %, based on the weight of the polyolefin and as determined by extraction in accordance with ASTM 5492.

9. The method according to claim 1, wherein the first mixture comprises, based on the weight of the first mixture:
from about 0.5 to about 5 wt. % of the organic peroxide; and,
from about 95 to about 99.5 wt. % of the ethylene vinyl acetate (EVA) copolymer.

10. The method according to claim 1, wherein the organic peroxide is selected from the group consisting of di-t-butyl-peroxide; t-butyl-cumyl-peroxide (BCUP); dicumyl peroxide; 1,3-bis(t-butylperoxyisopropyl)benzene; 2,5-dimethyl-2,5-di-t-butylperoxyhexane; 2,5-dimethyl-2,5-di-t-butyl-peroxyhex-3-yne; 4-methyl-2,2-di-t-butylperoxypentane; and t-butylperoxy 2-ethylhexyl carbonate.

11. The method according to claim 10, wherein the organic peroxide is selected from the group consisting of dicumyl peroxide; 2,5-dimethyl-2,5-di-t-butylperoxyhexane and tert-butylperoxy 2-ethylhexyl carbonate.

12. The method according to claim 1, wherein the EVA copolymer comprises, based on a total weight of the EVA copolymer:
from about 60 to about 90 wt. % of reacted units of ethylene; and,
from about 10 to about 40 wt. % of reacted units of vinyl acetate.

13. The method according to claim 11, wherein the EVA copolymer comprises, based on the weight of the EVA copolymer:
from about 70 to about 90 wt. % of reacted units of ethylene; and,
from 10 to 30 wt. % of reacted units of vinyl acetate.

14. The method according to claim 1, wherein at least a fraction of the organic peroxide and at least a fraction of the EVA copolymer are mixed prior to being fed into the first extruder.

15. The method according to claim 1, wherein at least a fraction of the organic peroxide and at least a fraction of the EVA copolymer are separately fed into the first extruder and mixed therein.

16. The method according to claim 1, wherein the crosslinkable ethylene vinyl acetate composition has a gel content of from about 60 to about 95%, as determined in accordance with ASTM D2765.

17. The method according to claim 1, wherein the crosslinkable ethylene vinyl acetate composition has a gel content of from about 80 to about 95%, as determined in accordance with ASTM D2765.

18. The method according to claim 1, wherein the second mixture comprises, based on the weight of the mixture:
from about 5 to about 20 wt. % of the cross-linkable EVA composition; and,
from about 80 to about 95 wt. % of the polyolefin.

19. The method according to claim 1, wherein the second mixture comprises, based on the weight of the mixture:
from about 5 to about 15 wt. % of the cross-linkable EVA composition; and,
from about 85 to about 95 wt. % of the polyolefin.

20. The method according to claim 1, wherein the melt extruding of the second mixture from the second extruder is conducted at a temperature of from about 200 to about 300° C.

21. The method according to claim 1, wherein the melt extruding of the second mixture from the second extruder is conducted at a temperature of from about 200 to about 250° C.

22. The method according to claim 1, wherein:
the second mixture has a residence time in the second extruder of from about 20 to about 400 seconds; and,
the specific energy input to the second extruder is from about 0.1 to 1 kWh per kg of the second mixture.

23. The method according to claim 1, wherein the extrudate from the second extruder is subjected to pelletization.

24. The method according to claim 1, wherein the extrudate from the second extruder is in the form of a film or one or more strands.
